(19) United States
(12) Patent Application Publication
(10) Pub. No.: US 2009/0005018 A1
(43) Pub. Date: Jan. 1, 2009

(54) Route Sharing and Location

(75) Inventors: Scott Forstall, Mountain View, CA (US); Gregory N. Christie, San Jose, CA (US); Robert E. Borchers, Pleasanton, CA (US); Kevin Tiene, Cupertino, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/019,035

(22) Filed: Jan. 24, 2008

Related U.S. Application Data
(60) Provisional application No. 60/946,866, filed on Jun. 28, 2007.

(51) Int. Cl. H04M 3/42

(52) U.S. Cl. 455/414.1

(57) ABSTRACT

A first mobile device can transmit data related to a route. A second mobile device can receive the route data from the first mobile device. The route data can be a route map displayed on a multi-touch-sensitive display of the second mobile device. A route engine can determine whether the second mobile device is at a location defined by a route locus based on the route data and location data of the second mobile device. The route engine can provide an indication at the first mobile device for a route location of the second mobile device based on the determination. The provided indication can be a route map with the route location of the second mobile device. The route map can include the route location of the second mobile device, directions to the route location, and an estimated travel time to the route location.

This application claims the benefit of U.S. Provisional Patent Application No. 60/946,866 filed Jun. 28, 2007, and entitled “ROUTE SHARING AND LOCATION” the disclosure of which is incorporated herein by reference.

### FIELD

This disclosure relates to routing services on a mobile device.

### BACKGROUND

Individuals can share routes with other individuals by use of mobile devices. The shared routes can include a series of directions to guide the individuals on the route, and can be displayed on a mobile device operated by the individuals. For example, a runner can share her favorite running route with her running partners, and they may schedule a time to run the route together.

Typically, however, the sharing of the route information must also be coordinated among the individuals by other communications, e.g., verbally or by e-mail. If, however, the persons sharing such routes are unable to otherwise communicate, then arranged meetings and/or schedules may not be met. For example, if an individual is late for a running group and the running group has started running along a running path, it can be difficult for the late individual to coordinate with the running group to determine its location.

### SUMMARY

Disclosed herein are systems and methods for routing services on a mobile device. In one implementation, data related to a route can be transmitted from a first mobile device to a second mobile device. The route data can include a route map that is transmitted to a multi-touch-sensitive display of the second mobile device. Location data related to the second mobile device can be received at the first mobile device. In one implementation, the location data can be received from a global positioning satellite (GPS) receiver connected to the second mobile device. At the first mobile device, it can be determined whether the second mobile device is at a location defined by a route locus based on the location data related to the second mobile device. An indication can be provided at the first mobile device for a route location of the second mobile device based on the determination. The indication provided at the first mobile device can be a route map that can include directions to the route location of the second mobile device.

In another implementation, data related to a route at a second mobile device can be received from a first mobile device. The route data can include a route map that is received at a multi-touch-sensitive display of the second mobile device. At the second mobile device, it can be determined whether the second mobile device is at a location defined by a route locus based on the route data. Route location data related to the second mobile device can be transmitted to the first mobile device based on the determination. The route location data transmitted to the first mobile device can be a route map that can include directions to the route location of the second mobile device.

In another implementation, a plurality of mobile devices can be configured to transmit and receive data related to a route. The first mobile device and the second mobile device can include a global positioning satellite receiver system sensor, a timer, and an alarm. A route engine can be configured to determine whether a first mobile device of the plurality of mobile devices is at a location defined by a route locus based on route data transmitted from a second mobile device of the plurality of mobile devices and location data of the first mobile device. A route engine can provide an indication at the second mobile device for a route location of the first mobile device based on the determination. In one implementation, the route engine can be implemented in the first mobile device and the second mobile device.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of an example mobile device.

FIG. 2 is a block diagram of an example network operating environment for the mobile device of FIG. 1.

FIG. 3 is a block diagram of an example implementation of the mobile device of FIG. 1.

FIG. 4 is a block diagram of an example network operating environment for the mobile device of FIG. 1.

FIG. 5 is a block diagram of an example mobile device depicting a request to share a route.

FIG. 6 is a block diagram of an example mobile device depicting a route.

FIG. 7 is a block diagram of an example mobile device depicting a user on a route.

FIG. 8 is a block diagram of an example mobile device depicting a request to share location information with another user.

FIG. 9 is a block diagram of an example mobile device depicting a user sharing location information with another user.

FIG. 10 is a flow diagram of an example process for transmitting a route between mobile devices and locating users of the mobile devices at a location defined by a route locus.

FIG. 11 is a flow diagram of an example process for locating users of mobile devices located in a proximity radius to a route.

FIG. 12 is a flow diagram of another example process for transmitting a route between mobile devices and locating users of the mobile devices at a location defined by a route locus.

FIG. 13 is a flow diagram of an example process for receiving a route invitation request.

### DETAILED DESCRIPTION

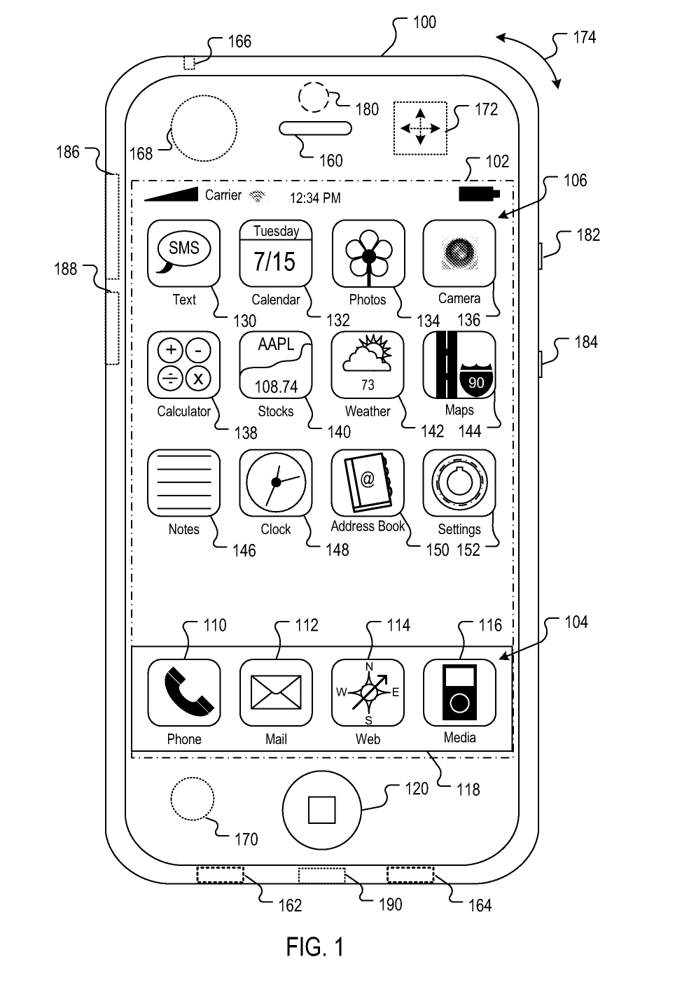

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or other electronic device or a combination of any two or more of these data processing devices or other data processing devices.

### Mobile Device Overview

In some implementations, the mobile device 100 includes a touch-sensitive display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and U.S. Patent Publication 2002/0015024A1, each of which is incorporated by reference herein in its entirety.

In some implementations, the mobile device 100 can display one or more graphical user interfaces on the touch-sensitive display 102 for providing the user access to various system objects and for conveying information to the user. In some implementations, the graphical user interface can include one or more display objects 104, 106. In the example shown, the display objects 104, 106, are graphic representations of system objects. Some examples of system objects include device functions, applications, windows, files, alerts, events, or other identifiable system objects.

### Example Mobile Device Functionality

In some implementations, the mobile device 100 can implement multiple device functionalities, such as a telephony device, as indicated by a phone object 110; an e-mail device, as indicated by the e-mail object 112; a network data communication device, as indicated by the Web object 114; a Wi-Fi base station device (not shown); and a media processing device, as indicated by the media player object 116. In some implementations, particular display objects 104, e.g., the phone object 110, the e-mail object 112, the Web object 114, and the media player object 116, can be displayed in a menu bar 118. In some implementations, device functionalities can be accessed from a top-level graphical user interface, such as the graphical user interface illustrated in FIG. 1. Touching one of the objects 110, 112, 114 or 116 can, for example, invoke corresponding functionality.

In some implementations, the mobile device 100 can implement network distribution functionality. For example, the functionality can enable the user to take the mobile device 100 and its associated network while traveling. In particular, the mobile device 100 can extend Internet access (e.g., Wi-Fi) to other wireless devices in the vicinity. For example, mobile device 100 can be configured as a base station for one or more devices. As such, mobile device 100 can grant or deny network access to other wireless devices.

In some implementations, upon invocation of device functionality, the graphical user interface of the mobile device 100 changes, or is augmented or replaced with another user interface or user interface elements, to facilitate user access to particular functions associated with the corresponding device functionality. For example, in response to a user touching the phone object 110, the graphical user interface of the touch-sensitive display 102 may present display objects related to various phone functions; likewise, touching of the email object 112 may cause the graphical user interface to present display objects related to various e-mail functions; touching the Web object 114 may cause the graphical user interface to present display objects related to various Web-surfing functions; and touching the media player object 116 may cause the graphical user interface to present display objects related to various media processing functions.

In some implementations, the top-level graphical user interface environment or state of FIG. 1 can be restored by pressing a button 120 located near the bottom of the mobile device 100. In some implementations, each corresponding device functionality may have corresponding “home” display objects displayed on the touch-sensitive display 102, and the graphical user interface environment of FIG. 1 can be restored by pressing the “home” display object.

In some implementations, the top-level graphical user interface can include additional display objects 106, such as a short messaging service (SMS) object 130, a calendar object 132, a photos object 134, a camera object 136, a calculator object 138, a stocks object 140, a weather object 142, a maps object 144, a notes object 146, a clock object 148, an address book object 150, and a settings object 152. Touching the SMS display object 130 can, for example, invoke an SMS messaging environment and supporting functionality; likewise, each selection of a display object 132, 134, 136, 138, 140, 142, 144, 146, 148, 150 and 152 can invoke a corresponding object environment and functionality.

Additional and/or different display objects can also be displayed in the graphical user interface of FIG. 1. For example, if the device 100 is functioning as a base station for other devices, one or more “connection” objects may appear in the graphical user interface to indicate the connection. In some implementations, the display objects 106 can be configured by a user, e.g., a user may specify which display objects 106 are displayed, and/or may download additional applications or other software that provides other functionalities and corresponding display objects.

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, a loud speaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Accordingly, display objects and/or media can be presented according to a detected orientation, e.g., portrait or landscape. In some implementations, the mobile device 100 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 100 or provided as a separate device that can be coupled to the mobile device 100 through an interface (e.g., port device 190) to provide access to location-based services.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

In some implementations, a port device 190, e.g., a Universal Serial Bus (USB) port, or a docking port, or some other wired port connection, can be included. The port device 190 can, for example, be utilized to establish a wired connection to other computing devices, such as other communication devices 100, network access devices, a personal computer, a printer, or other processing devices capable of receiving and/or transmitting data. In some implementations, the port device 190 allows the mobile device 100 to synchronize with a host device using one or more protocols, such as, for example, the TCP/IP, HTTP, UDP and any other known protocol.

### Network Operating Environment

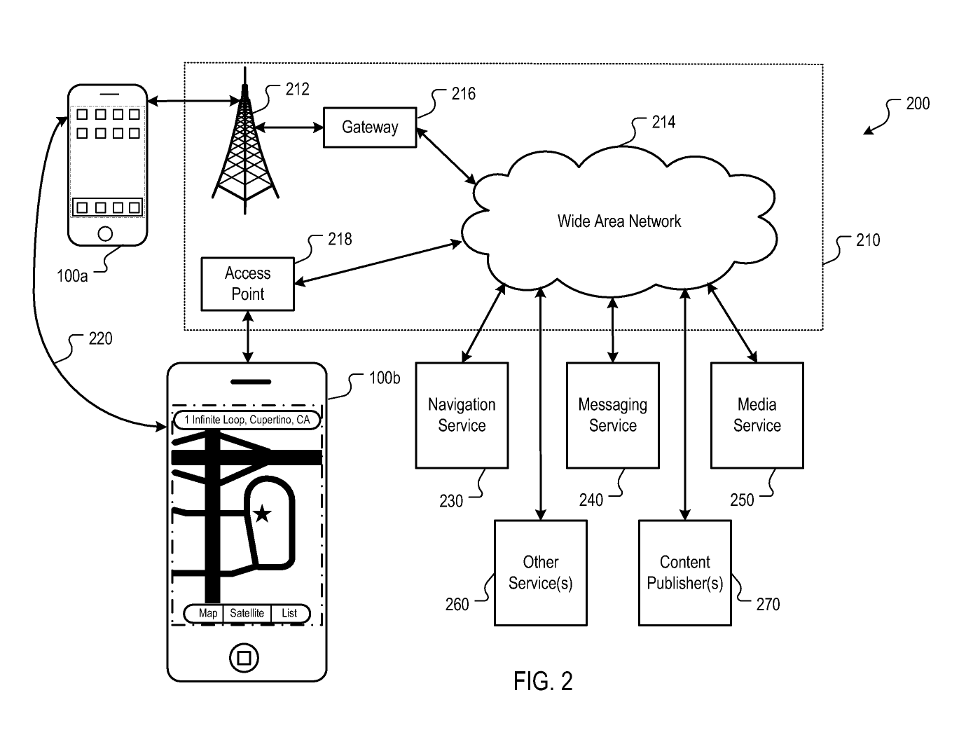

FIG. 2 is a block diagram of an example network operating environment 200 for the mobile device 100 of FIG. 1. The mobile device 100 of FIG. 1 can, for example, communicate over one or more wired and/or wireless networks 210 in data communication. For example, a wireless network 212, e.g., a cellular network, can communicate with a wide area network (WAN) 214, such as the Internet, by use of a gateway 216. Likewise, an access point 218, such as an 802.11g wireless access device, can provide communication access to the wide area network 214. In some implementations, both voice and data communications can be established over the wireless network 212 and the access point 218. For example, the mobile device 100a can place and receive phone calls (e.g., using VoIP protocols), send and receive e-mail messages (e.g., using POP3 protocol), and retrieve electronic documents and/or streams, such as web pages, photographs, and videos, over the wireless network 212, gateway 216, and wide area network 214 (e.g., using TCP/IP or UDP protocols). Likewise, the mobile device 100b can place and receive phone calls, send and receive e-mail messages, and retrieve electronic documents over the access point 218 and the wide area network 214. In some implementations, the mobile device 100 can be physically connected to the access point 218 using one or more cables and the access point 218 can be a personal computer. In this configuration, the mobile device 100 can be referred to as a “tethered” device.

The mobile devices 100a and 100b can also establish communications by other means. For example, the wireless device 100a can communicate with other wireless devices, e.g., other wireless devices 100, cell phones, etc., over the wireless network 212. Likewise, the mobile devices 100a and 100b can establish peer-to-peer communications 220, e.g., a personal area network, by use of one or more communication subsystems, such as the Bluetooth™ communication device 188 shown in FIG. 1. Other communication protocols and topologies can also be implemented.

The mobile device 100 can, for example, communicate with one or more services 230, 240, 250, and 260 and/or one or more content publishers 270 over the one or more wired and/or wireless networks 210. For example, a navigation service 230 can provide navigation information, e.g., map information, location information, route information, and other information, to the mobile device 100. In the example shown, a user of the mobile device 100b has invoked a map functionality, e.g., by pressing the maps object 144 on the top-level graphical user interface shown in FIG. 1, and has requested and received a map for the location “1 Infinite Loop, Cupertino, Calif.”

A messaging service 240 can, for example, provide e-mail and/or other messaging services. A media service 250 can, for example, provide access to media files, such as song files, movie files, video clips, and other media data. One or more other services 260 can also be utilized by the mobile device 100.

The mobile device 100 can also access other data and content over the one or more wired and/or wireless networks 210. For example, content publishers 270, such as news sites, RSS feeds, web sites, blogs, social networking sites, developer networks, etc., can be accessed by the mobile device 100. Such access can be provided by invocation of a web browsing function or application (e.g., a browser) in response to a user touching the Web object 114.

### Example Mobile Device Architecture

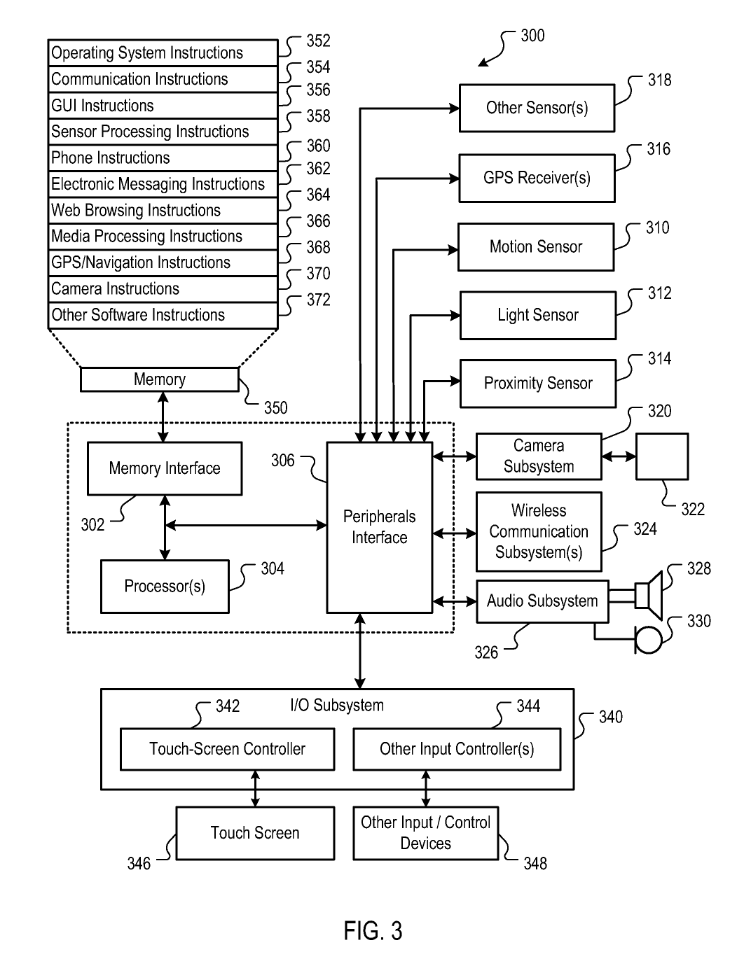

FIG. 3 is a block diagram 300 of an example implementation of the mobile device 100 of FIG. 1. The mobile device 100 can include a memory interface 302, one or more data processors, image processors and/or central processing units 304, and a peripherals interface 306. The memory interface 302, the one or more processors 304 and/or the peripherals interface 306 can be separate components or can be integrated in one or more integrated circuits. The various components in the mobile device 100 can be coupled by one or more communication buses or signal lines.

Sensors, devices and subsystems can be coupled to the peripherals interface 306 to facilitate multiple functionalities. For example, a motion sensor 310, a light sensor 312, and a proximity sensor 314 can be coupled to the peripherals interface 306 to facilitate the orientation, lighting and proximity functions described with respect to FIG. 1. Other sensors 318 can also be connected to the peripherals interface 306, such as a positioning system (e.g., GPS receiver), a temperature sensor, a biometric sensor, or other sensing device, to facilitate related functionalities.

A camera subsystem 320 and an optical sensor 322, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 324, which can include radio frequency receivers and transmitters and/or optical (e.g., infrared) receivers and transmitters. The specific design and implementation of the communication subsystem 324 can depend on the communication network(s) over which the mobile device 100 is intended to operate. For example, a mobile device 100 may include communication subsystems 324 designed to operate over a GSM network, a GPRS network, an EDGE network, a Wi-Fi or WiMax network, and a Bluetooth™ network. In particular, the wireless communication subsystems 324 may include hosting protocols such that the device 100 may be configured as a base station for other wireless devices.

An audio subsystem 326 can be coupled to a speaker 328 and a microphone 330 to facilitate voice-enabled functions, such as voice recognition, voice replication, digital recording, and telephony functions.

The I/O subsystem 340 can include a touch screen controller 342 and/or other input controller(s) 344. The touch-screen controller 342 can be coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346.

The other input controller(s) 344 can be coupled to other input/control devices 348, such as one or more buttons, rocker switches, thumb-wheel, infrared port, USB port, and/or a pointer device such as a stylus. The one or more buttons (not shown) can include an up/down button for volume control of the speaker 328 and/or the microphone 330.

In one implementation, a pressing of the button for a first duration may disengage a lock of the touch screen 346; and a pressing of the button for a second duration that is longer than the first duration may turn power to the mobile device 100 on or off. The user may be able to customize a functionality of one or more of the buttons. The touch screen 346 can, for example, also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod™. The mobile device 100 may, therefore, include a 36-pin connector that is compatible with the iPod. Other input/output and control devices can also be used.

The memory interface 302 can be coupled to memory 350. The memory 350 can include high-speed random access memory and/or non-volatile memory, such as one or more magnetic disk storage devices, one or more optical storage devices, and/or flash memory (e.g., NAND, NOR). The memory 350 can store an operating system 352, such as Darwin, RTXC, LINUX, UNIX, OS X, WINDOWS, or an embedded operating system such as VxWorks. The operating system 352 may include instructions for handling basic system services and for performing hardware dependent tasks. In some implementations, the operating system 352 can be a kernel (e.g., UNIX kernel).

The memory 350 may also store communication instructions 354 to facilitate communicating with one or more additional devices, one or more computers and/or one or more servers. The memory 350 may include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes and instructions; camera instructions 370 to facilitate camera-related processes and functions; and/or other software instructions 372 to facilitate other processes and functions.

Each of the above identified instructions and applications can correspond to a set of instructions for performing one or more functions described above. These instructions need not be implemented as separate software programs, procedures or modules. The memory 350 can include additional instructions or fewer instructions. Furthermore, various functions of the mobile device 100 may be implemented in hardware and/or in software, including in one or more signal processing and/or application specific integrated circuits.

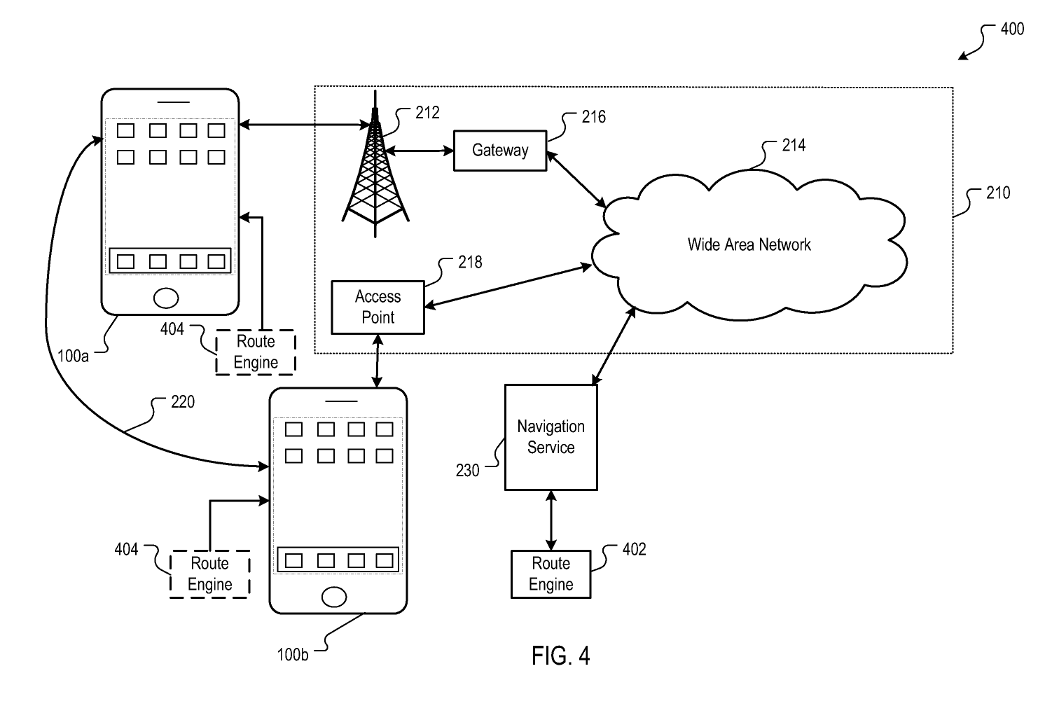

FIG. 4 is a block diagram of another example network operating environment 400 for the mobile device 100 of FIG. 1. In one implementation, multiple mobile devices can be configured to transmit and receive data related to a route, and to locate other users on the route. For example, the route can be a running route, a walking route, an in-line skating route, a bicycle route, a backpacking route, a hiking route, a driving route, etc. The data related to the route can include a series of directions associated with the route, a total distance associated with the route, an estimated total time associated with completing the route, an average pace associated with the route, average split times associated with route, etc. The locations of users on the route can be displayed on the mobile device 100.

In one implementation, the route data can be a series of directions that is tracked by one of the multiple mobile devices, e.g., the second mobile device 100b. For example, the GPS receiver 316 can be coupled to the peripherals interface 306 of the first mobile device 100a and the second mobile device 100b. The GPS receiver 316 and GPS/Navigation instructions 368 can, for example, be used to facilitate the GPS and navigation-related processes and instructions with regards to tracking a route. In other implementations, other positioning systems can also be used, e.g., location data can be derived by using wireless signal strength and one or more locations of known wireless signal sources to provide current location. Wireless signal sources can include access points and/or cellular towers. Other location signaling systems can also be used, e.g., location instrumentation deployed over an area, such as a city, and which include location transmitters or transceivers that transmit location data to the mobile device and from which the mobile device can derive or determine a current location, etc. In still other implementations, the user can enter a set of position coordinates (e.g., latitude, longitude) for the mobile device. For example, the position coordinates can be typed into the mobile device (e.g., using a virtual keyboard) or selected by touching a point on a map. Position coordinates can also be acquired from another location-enable device by syncing or linking with the other device.

A user of the second mobile device 100b can, for example, enable the second mobile device 100b to track and store a route, such as a running route, a walking route, a bicycling route, etc. In some implementations, the user can enable the second mobile device 100b to start tracking the route at a geographic location and to stop tracking the route at the geographic location at the completion of the route. In other implementations, The GPS receiver 316 and the GPS/Navigation instructions 368 can, for example, be utilized to track the route. The second mobile device 100b can store the series of directions associated with the tracked route, and other data, such as the total distance associated with the tracked route, the total time associated with completing the tracked route, the pace associated with the tracked route, average split times associated with the tracked route, etc.

In some implementations, the second mobile device 100b can begin tracking a route upon the occurrence of a triggering event. For example, a user of the second mobile device 100b can define a triggering event to occur when the user of the second mobile device 100b begins running. Thus, if user desires to record a running route, the user may simply walk to a suitable location that the user chooses to be the beginning of the route, and then may start running without manual input to the second mobile device 100b. Other triggers can also be set to stop recording a running route, e.g., after walking for 30 seconds, etc.

The determination as to whether a user is running or walking can be determined by a rate calculation. For example, distances measured by GPS readings can be divided by time to determine the current speed of the second mobile device 100b. If the speed is above a threshold, e.g., five miles an hour, the second mobile device 110b can determine that a running triggering event has occurred.

Other triggering events can also be used to record routes, or to enable and/or disable mobile device 100 operations.

In another implementation, the route data can be a series of directions associated with a route that can be downloaded from a website that contains a variety of different routes that have been submitted by users. For example, the website can be searched to locate routes that are located near the user. The second mobile device 100b can store the downloaded route, and other data, such as the directions associated with the downloaded route, the total distance associated with the downloaded route, the total time associated with completing the downloaded route, the pace associated with the downloaded route, average split times associated with the downloaded route, etc.

In one implementation, the first mobile device 100a can be configured to receive the route data from the second mobile device 100b. For example, the mobile devices 100a and 100b can establish peer-to-peer communications 220 to transmit and receive the route data, or can transmit and receive the route data over a network, such as the wide area network 214, or the one or more networks 210.

In one implementation, the route data received by the first mobile device 100a can include a route map displayed on a multi-touch-sensitive display of the first mobile device 100a. For example, when the first mobile device 100a receives the route data from the second mobile device 100b, the route data can be presented as a map displaying the directions of the route. Additional route details, such as the directions associated with the route, the total distance associated with the route, the total time associated with completing the route, the pace associated with the route, average split times associated with the route, can also be presented.

In another implementation, the route data received by the first mobile device 100a can include a route invitation request displayed on the first mobile device 100a. For example, a route invitation request can be an invitation from a user of the second mobile device 100b to locate the user of the first mobile device 100a when the user is at a location defined by a route locus. The route invitation request can, for example, be accepted by the user of the first mobile device 100a if the user would like for the user of the second mobile device 100b to be able to locate him/her. In another implementation, the route invitation request can, for example, be denied by the user of the first mobile device 100a if the user would not like for the user of the second mobile device 100b to be able to locate him/her.

In one implementation, a route engine 402 can be implemented in the navigation service 230. The mobile devices 100a and 100b can, for example, communicate with the route engine 402 via the navigation service 230 over the one or more wired and/or wireless networks 210. For example, the navigation service 230 can be invoked by a user of the mobile device pressing the maps object 144 on the top-level graphical user interface shown in FIG. 1. In some implementations, the navigation service 230 can provide a subscription based service for which users of the mobile devices 100a and 100b pay a periodic fee to use the services.

In another implementation, a mobile device route engine 404 can be implemented in the first mobile device 100a and the second mobile device 100b. For example, the functions of the mobile device route engine 404 described below can be implemented in the mobile devices 100a and 100b without communicating with the navigation service 230 over the one or more wired and/or wireless networks 210. The implementation of the mobile device route engine 404 in the mobile devices 100a and 100b can facilitate the communication of route data between the mobile devices 100a and 100b.

In one implementation, the route engine 402, or the mobile device route engine 404, can be configured to determine whether a first mobile device 100a is at a location defined by a route locus based on route data transmitted from a second mobile device 100b and location data of the first mobile device 100a. For example, the route engine 402, or the mobile device route engine 404, can retrieve location data from the first mobile device 100a. The location data can represent the current location of the first mobile device 100a. The location data can, for example, be determined by the GPS receiver 316 of the first mobile device 100a.

In one implementation, a route locus can define one or more locations conterminous with a route, e.g., one or more locations on the route. In another implementation, the route locus can define locations within a predefined proximity of the route. In another implementation, predefined proximity can define locations within a proximity radius of the route.

In one implementation, the route engine 402, or the mobile device route engine 404, can compare the location data of the first mobile device 100a with the route data. The route engine 402, or the mobile device route engine 404, can determine whether the location data of the first mobile device 100a matches a location associated with the route data. For example, the location data of the first mobile device 100a can include GPS coordinates for a location. The route engine 402, or the mobile device route engine 404, can compare the GPS coordinates of the first mobile device 100a and determine whether the GPS coordinates are at a location defined by a route locus associated with the route data.

In one implementation, the user of the second mobile device 100b can set up preferences to define the proximity radius that defines a range around the route that the user of the second mobile device 100b can be notified of the presence of the first mobile device 100a. For example, the user of a second mobile device 100b can determine that if the first mobile device 100a was within one mile of the route, the user can receive a notification.

In one implementation, the route engine 402, or the mobile device route engine 404, can utilize the proximity radius defined by the user of the second mobile device 100b to expand the route location data by the proximity radius. The route engine 402, or the mobile device route engine 404, can then compare the location data of the first mobile device 100a with the route expanded by the proximity radius. The route engine 402, or the mobile device route engine 404, can determine whether the location data of the first mobile device 100a matches a location associated with the route expanded by the proximity radius. For example, the location data of the first mobile device 100a can include GPS coordinates for a specific location. The route engine 402, or the mobile device route engine 404, can compare the GPS coordinates of the first mobile device 100a and determine whether the GPS coordinates are approximate to a location on the route expanded by the proximity radius.

In one implementation, the route engine 402, or the mobile device route engine 404, can be configured to provide an indication at the second mobile device 100b for a route location of the first mobile device 100a based on the determination that the first mobile device 100a is at a location defined by a route locus. For example, the provided indication can serve as notification to the user of the second mobile device 100b that the user of the first mobile device 100a is currently located at a location defined by a route locus.

In one implementation, the indication can be provided to a multi-touch-sensitive display of the second mobile device 100b. For example, the indication can be a message received by the second mobile device 100b. The message can include a route map with the route location of the first mobile device 100a on a multi-touch-sensitive display of the second mobile device 100b. In one implementation, the route map can include directions to the route location of the first mobile device 100a. In another implementation, the route map can include an estimated travel time to the route location of the first mobile device 100a.

In one implementation, the first mobile device 100a and the second mobile device 100b can include an alarm. For example, the alarm can provide an audible alert in response to an indication provided by the route engine 402, or the mobile device route engine 404. The alarm can, for example, be implemented by the speaker 328 of the mobile device 100 of FIG. 1. The users of the mobile devices 100a and 100b can adjust the settings of the alarm to provide a different audible alert in response to certain events. For example, the user can define different audible alerts for different users of mobile devices 100.

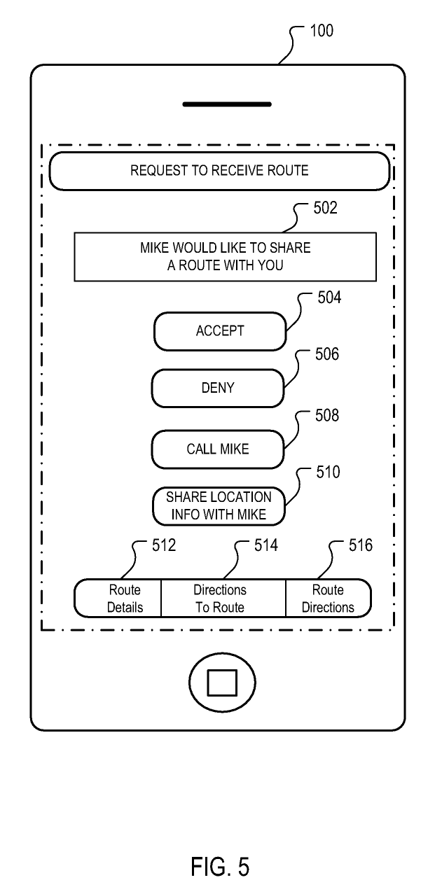

FIG. 5 is a block diagram of an example mobile device 100 depicting a request to receive a route. For example, a user operating a mobile device 100 may receive an indication on the mobile device 100, such as an audible alert, a vibration, a message on the multi-touch-sensitive display, etc., with a request from another user to share a route. For example, in the example depicted in FIG. 5, the user operating the mobile device receives a message 502 on the multi-touch-sensitive display from a user named Mike with a request to share a route.

In one implementation, the user operating the mobile device 100 can accept the request 504 from Mike or deny the request 506 from Mike by selecting the corresponding location on the multi-touch-sensitive display. In another implementation, the user operating the mobile device 100 can call the user, Mike, 508 who is presenting the request to share the route.

In another implementation, in response to accepting the request 504 from Mike, the user operating the mobile device 100 can be presented with an option to share his/her location information with Mike 510. For example, the user operating the mobile device 100 may determine to accept the request 504 to receive the route from Mike; however, the user operating the mobile device 100 may prefer not to share his/her location information to Mike if both the user and Mike are at a location defined by a route locus, e.g. at one or more locations coterminous with the route or within a predefined proximity of the route.

In another implementation, additional information regarding the route associated with the request can be presented to the user of the mobile device 100. For example, route details 512, directions to the route 514, and route directions 516 can be displayed on the mobile device 100. The route details 512 can include a total distance associated with the route, an estimated total time associated with completing the route, an average pace associated with the route, average split times associated with the route, elevation along the route, etc. The directions to the route 514 can include directions from the user's current location to a location on the route. The route directions 516 can include directions a user can follow to complete the route.

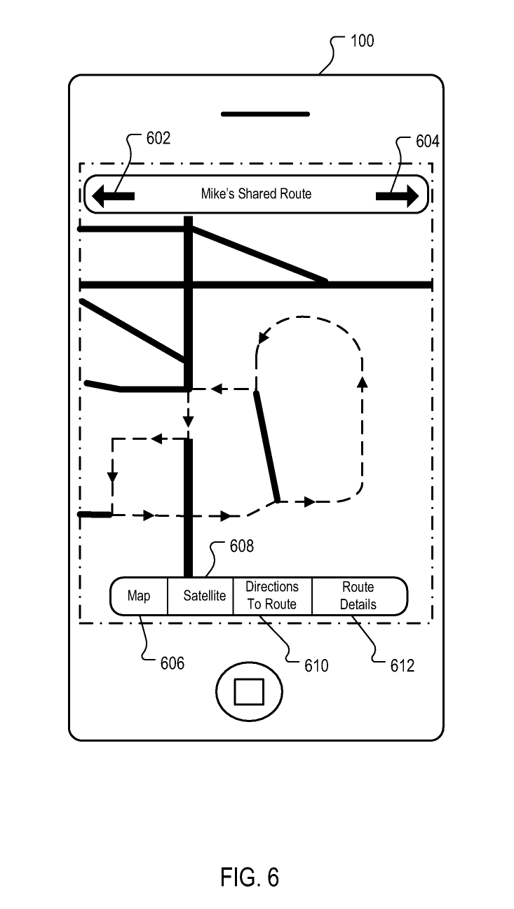

FIG. 6 is a block diagram of an example mobile device 100 depicting a route. For example, in response to the request from Mike in FIG. 5, the user operating the mobile device 100 can accept 504 the request to receive Mike's route by selecting the corresponding location on the multi-touch-sensitive display of the mobile device 100. In response to the user's acceptance, Mike's route can be displayed on the multi-touch-sensitive display of the mobile device 100.

In one implementation, scrolling arrows 602 and 604 can be displayed on the multi-touch-sensitive display while viewing different routes. The scrolling arrows 602 and 604 can allow a user operating the mobile device 100 to scroll backwards 602 or forwards 604 to review additional routes.

In another implementation, additional information related to the currently displayed route can be presented to the user of the mobile device 100. For example, a route map 606, a route satellite map 608, directions to the route 610; and route details 612 can be displayed on the mobile device 100. The route map 606, for which an example is depicted in FIG. 6, can include a map of the route path. The route satellite map 608 can include satellite imagery of the route path. The directions to the route 610 can include the directions from the user's current location to a location on the route. The route details 612 can include a total distance associated with the route, an estimated time associated with completing the route, an average pace associated with the route, average split times associated with the route, etc. Additional information can also be displayed to the user related to the currently displayed route.

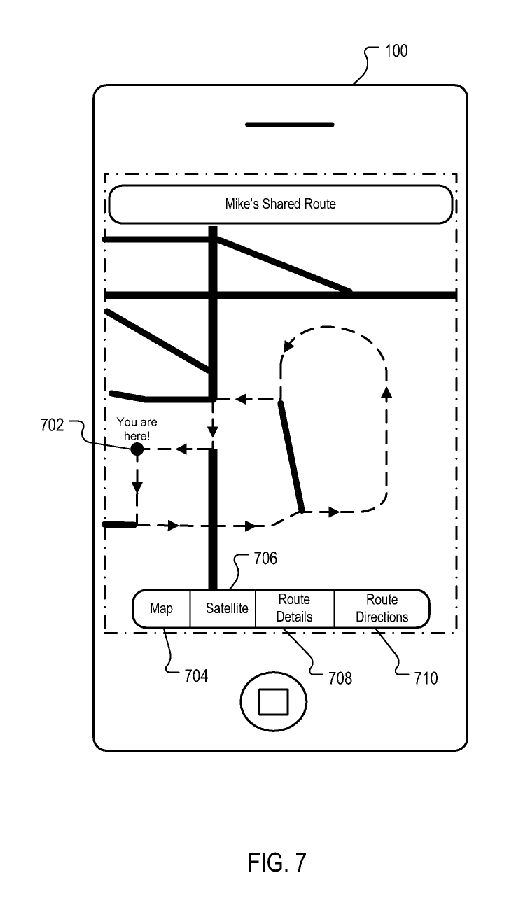

FIG. 7 is a block diagram of an example mobile device 100 depicting a user on a route. For example, in response to the display of Mike's route depicted in FIG. 6, the user operating the mobile device 100 can select the directions to the route 610 by selecting the corresponding location on the multi-touch-sensitive display. The directions to the route 610 displayed on the mobile device 100 can lead the user to a point on the shared route. The user's location on the route 702 can be depicted on the mobile device 100 as shown in FIG. 7.

In another implementation, additional information related to the currently displayed route can be presented to the user of the mobile device 100. For example, a route map 704, a route satellite map 706, route details 708, and route directions 710 can be displayed on the mobile device 100. The route map 704, for which an example is depicted in FIG. 7, can include a map of the route path. The route satellite map 706 can include satellite imagery of the route path. The route details 708 can include a total distance associated with the route, an estimated time associated with completing the route, an average pace associated with the route, average split times associated with the route, etc. The route directions 710 can include the directions a user can follow to complete the route. Additional information can also be displayed to the user related to the currently displayed route.

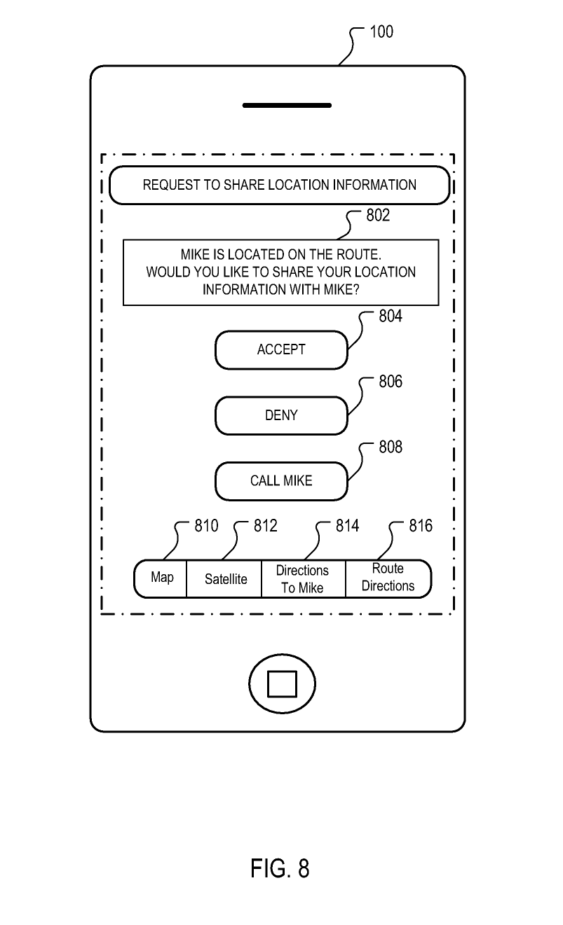

FIG. 8 is a block diagram of an example mobile device depicting a request to share location information with another user. For example, a user operating a mobile device 100 can receive an indication on the mobile device 100, such as an audible alert, a vibration, a message on the multi-touch-sensitive display, etc, with a notification that another user is at a location defined by a route locus, e.g. at one or more locations coterminous with the route or within a predefined proximity of the route.

In one implementation, a user operating the mobile device 100 can indicate his/her preferences on the mobile device 100 with regards to when the user can be notified with respect to the sharing his/her location information with other users. For example, the user can set up preferences for each individual located in a user's contact list. For example, the user can set his/her preferences to where his/her location information can always be displayed to another user named Brad, if Brad is at a location defined by a route locus, e.g. at one or more locations coterminous with the route or within a predefined proximity of the route. However, the user can set his/her preferences to where his/her location information can never be displayed to another user named Karen, if Karen is at a location defined by a route locus to the same route as the user, unless the user approves to share his/her location information with Karen.

In one implementation, a user operating the mobile device 100 can indicate his/her preferences on the mobile device 100 with regards to when the user can receive location information with respect to other users. For example, the user can set preferences for each individual located in a user's contact listing based on particular distances. For example, the user can set his/her preferences so that the user is notified when another user named Christopher is within 200 yards of the user on the same route. In another example, the user can set his/her preferences so that the user is notified when Kimberly is within a one mile proximity radius to a location on the same route.

In the example depicted in FIG. 8, the user operating the mobile device 100 can receive a request 802 on the multi-touch-sensitive display requesting permission to allow Mike to receive the user's location information. The request from Mike can, for example, be transmitted to the user because Mike is at a location defined by a route locus to the same route as the user. For example, the user's preferences may indicate that the user's approval is required to share his/her location information with Mike when Mike is at a location coterminous to the route or in a predefined proximity to the route. In one implementation, the user operating the mobile device 100 can accept the request 804 or deny the request 806 to share his/her location with Mike by selecting the corresponding location on the multi-touch-sensitive display. In another implementation, the user operating the mobile device 100 can call Mike 808.

In another implementation, additional information related to the request to share the user's location information can be presented to the user of the mobile device 100. For example, a route map 810, a route satellite map 812, directions to the requesting individual 814, i.e., Mike, and route directions 816 can be displayed on the mobile device 100. The route map 810 can include a map of the route path with the location of the user and Mike. The route satellite map 812 can include satellite imagery of the route path with the location of the user and Mike. The route satellite map 812 can be beneficial in determining geographic landmarks that an individual may be close to. The directions to Mike 814 can include the directions a user can follow to locate Mike on the route. The route directions 816 can include the directions a user can follow to complete the route, without regard to Mike's location. Additional information can also be displayed to the user related to the request to share the user's location information.

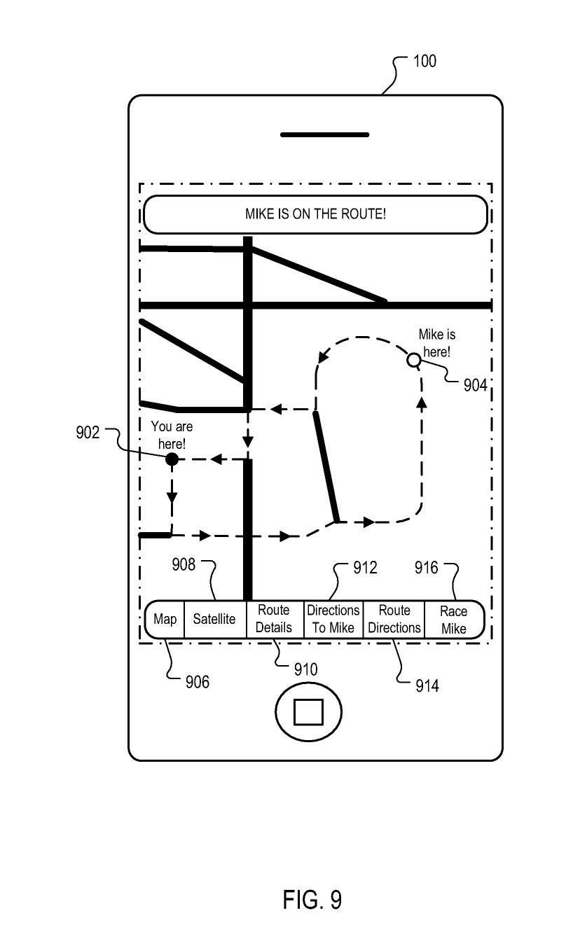

FIG. 9 is a block diagram of an example mobile device depicting a user sharing location information with another user. In the example depicted in FIG. 9, the user operating the mobile device 100 can accept the request 804 on the multi-touch-sensitive display requesting permission to allow Mike to see the user's location information. The user's location on the route 902 and Mike's location on the route 904 can be depicted on the multi-touch-sensitive display of the mobile device 100, as shown in FIG. 9.

In another implementation, additional information related to a user sharing location information with another user on a route can be presented to the user of the mobile device 100. For example, a route map 906, a route satellite map 908, route details 910, directions to the other user, Mike, 912, and route directions 914 can be displayed on the mobile device 100. The route map 906 can include a map of the route path with the location of the user and Mike. The route satellite map 908 can include satellite imagery of the route path with the location of the user and Mike. The route satellite map 908 can be beneficial in determining geographic landmarks that an individual may be close to.

The route details 910 can include a total distance associated with the route, an estimated total time associated with completing the route, an average pace associated with the route, average split times associated with the route, etc. The directions to Mike 912 can include the directions a user can follow to locate Mike on the route, and an estimated travel time to reach Mike. The route directions 914 can include the directions a user can follow to complete the route, without regards to Mike's location. Additional information can also be displayed to the user related to the request to share the user's location information.

In another implementation, a race feature 916 can be presented to the user of the mobile device 100. For example, when the user of the mobile device 100 selects the race feature 916, an invitation can be transmitted to one or more other users operating mobile devices 100 that are at a location defined by a route locus. For example, in FIG. 9, if the user operating the mobile device 100 selects the race feature 916, an invitation can be sent to Mike's mobile device inviting him to race.

In one implementation, details regarding the race can be sent to the one or more users who have accepted an invitation to participate in the race. For example, the race initiator can define particular guidelines for the race based on the route. The race initiator can define the length of the race, the length of time of the race, the start time of the race, etc. For example, in FIG. 9, the race initiator can be the user of the displayed mobile device 100 who selects the race feature 916. The user may decide that the current race will be one lap around the route that the user and Mike are located on, whereby the individual with the fastest lap time wins.

In one implementation, the starting locations of the one or more users who have accepted an invitation to participate in the race can be determined. For example, the starting locations of the participating users can be determined by the GPS receiver 316 located on the mobile devices 100 of the participating users. The GPS receiver 316 can determine the starting locations of the participating users at the start time of the race. The starting location information for each of the participating users can be transmitted to the other participating users and displayed on their respective mobile devices 100. For example, in FIG. 9, Mike's starting position 904 can be transmitted to the user of the displayed mobile device 100. Furthermore, the starting location 902 of the user can be transmitted to Mike's mobile device.

In one implementation, the locations of the participating users can be displayed to the other participating users during the race. For example, the participating users can begin racing at the start time. The GPS receiver 316 located on the mobile devices 100 of the participating users can determine the locations of the participating users at any given time during the race. The location information for each of the participating users can be transmitted to the other participating users and displayed on a race route map on the user's respective mobile devices 100. For example, while not shown in FIG. 9, Mike's location information can be transmitted to the user of the displayed mobile device 100 at any given time during the race. Furthermore, the location information of the user can be transmitted to Mike's mobile device.

In one implementation, additional information regarding the participating users can be transmitted to the other participating users. For example, the participating user information can include an average pace time for each of the participating users, a total distance traveled for each of the participating users, a projected finish time for each of the participating users, average split times for each of the participating users, etc. The participating users information can, for example, be determined by a route engine 402 or a mobile device route engine 404 located in the mobile devices 100 of the participating users. In one implementation, the user of a mobile device 100 can select a location of a participating user displayed on the race route map to view the participating user information associated with that participating user. In another implementation, a user operating a mobile device can view her own participating user information.

In one implementation, the current standings of the race can be determined and transmitted to the participating users For example, the current standings can be determined by ranking the participating users in order of which participating user has completed the highest portion of the race route. The current standings information can, for example, be determined at any given time during the race and transmitted to the participating users.

In one implementation, the participating users can be notified when a participating user completes the race. For example, as participating users complete the race, notifications can be sent to the other participating users identifying which position that the participating user placed in the final standings. The final position standings can be transmitted to the participating users until the last participating user has completed the race.

In one implementation, the participating user's information can be transmitted to a user racing service. For example, the mobile device can communicate with the user racing service over the one or more wired and/or wireless networks 210. The user racing service can, for example, store participating user information for multiple users. The participating user information can include historical race position information, e.g., standings information, average pace times associated with a user for multiple races, total distances traveled for a user, average split times associated with a user for multiple races, race details for races a user has participated, e.g., race routes, race locations, race distances, race dates and times, etc.

In one implementation, the user racing service can determine standings information for multiple users. For example, the user racing service can determine standings information for different routes. The user racing service can, for example, compile participating user information for a race route and rank the best performing users, e.g., the user with the fastest completion time, on the race route. In one implementation, users of a mobile device on a race route can access the standings information for the race route to determine what time the user would need to complete the race route in order to obtain the fastest completion time for that race route. In one implementation, the user racing service can transmit race route information while the user is participating in the race. For example, the race route information can include an estimated completion time for the user; the user's average split times, etc.

In some implementations, users of the mobile devices 100 can conduct virtual or “ghost” races. For example, a group of users may agree to race a route any time over a coming week. Each user can run the route at any time during the week. As each user races the route, race data for that user are provided to the user racing service. After all the users have raced the route, the results of the race, including race data, can be provided to the mobile devices of the users. The results can be used to show the relative progress of the users during the race, can be displayed on the mobile devices 100 for each of the users.

In some implementations, the race data for each user can be provided to other mobile devices after each user runs the race. In other implementations, the race data received for other users can be used to display the relative position of a user currently running in the virtual race. For example, if a user is a third runner in the virtual race, the user may track his or her progress during the race relative to the progress of the previous two competitors that previously completed the race route.

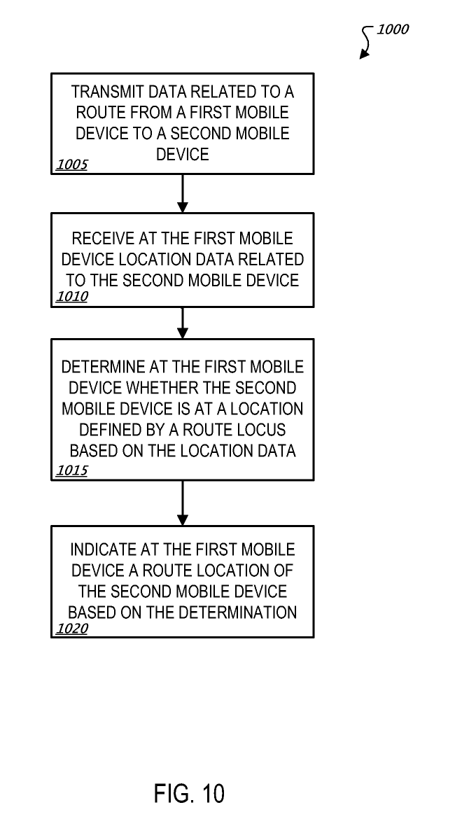

FIG. 10 is a flow diagram of an example process for transmitting a route between mobile devices and locating users of the mobile devices at a location defined by a route locus. The process 1000 can, for example, be implemented in a route engine 402, or a mobile device route engine 404. In one implementation, the mobile device route engine 404 can be integrated in the mobile devices 100a and 100b. In another implementation, the route engine 402 can be integrated in a navigation service 230, which can be accessible by the mobile devices 100a and 100b over one or more wired and/or wireless networks 210.

Stage 1005 transmits data related to a route from a first mobile device to a second mobile device. In one implementation, transmitting the route data can include presenting a route map to a multi-touch-sensitive display of the second mobile device 100b. In another implementation, transmitting the route data can include transmitting a route invitation request to the second mobile device 100b requesting the second mobile device 100b to share location information with the first mobile device 100a when the mobile devices 100a and 100b are at a location defined by a route locus to the route.

Stage 1010 receives at the first mobile device location data related to the second mobile device. In one implementation, the location data received at the first mobile device 100a can be based on data from a global positioning satellite receiver 316 in communication with the second mobile device 100b. Other means for determining the location data of the second mobile device 100b can also be used.

Stage 1015 determines at the first mobile device whether the second mobile device is at a location defined by a route locus based on the location data. In one implementation, determining whether the second mobile device is at a location defined by a route locus can be performed by comparing location data from the second mobile device 100b to the route data received of the first mobile device 100a. Determining whether the second mobile device is at a location defined by a route locus can, for example, be determined by a route engine 402 or a mobile device route engine 404 located in the first mobile device 100a.

Stage 1020 indicates at the first mobile device a route location of the second mobile device based on the determination that the second mobile device is at a location defined by a route locus. In one implementation, indicating a route location of the second mobile device 100b at the first mobile device 100a can include sounding an audible alert at the first mobile device 100a. In another implementation, the indication can include displaying a route map with the route location of the second mobile device 100b on a multi-touch-sensitive display of the first mobile device 100a. In another implementation, the indication can include displaying directions to the route location. In another implementation, the indication can include displaying an estimated travel time to the route location.

Other processes for transmitting a route between mobile devices and locating users of the mobile devices on the route can also be used.

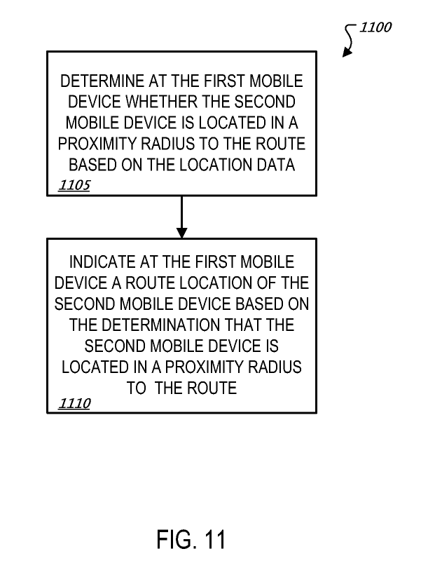

FIG. 11 is a flow diagram of an example process for locating users of mobile devices located in a proximity radius to a route. The process 1100 can, for example, be implemented in the route engine 402 or the mobile device route engine 404.

Stage 1105 determines at a first mobile device whether a second mobile device is located in a proximity radius to the route based on the location data of the second mobile device. In one implementation, preferences can be setup to define a proximity radius that defines a range around a route that a user can be notified of another user. For example, a user operating a mobile device can determine that if another user operating a mobile device was within one mile of the route, the user can receive a notification.

In one implementation, the proximity radius defined by the user of the first mobile device 100a can be used to expand the route location data by the proximity radius. The location data of the second mobile device 100b can then be compared with the route expanded by the proximity radius. For example, the location data can be determined from a global positioning satellite receiver 316 in communication with the second mobile device 100b. It can then, for example, be determined whether the second mobile device 100b is located in the proximity radius of the route. For example, the location data of the second mobile device 100b can be compared to the route expanded by the proximity radius to determine whether there is a match associated with a location on the route expanded by the proximity radius. Determining whether the second mobile device is located in a proximity radius to the route can, for example, be determined by a route engine 402 or a mobile device route engine 404 located in the first mobile device 100a.

Stage 1110 indicates at the first mobile device a route location of the second mobile device based on the determination that the second mobile device is located in a proximity radius to the route. For example, indicating a route location of the second mobile device 100b at the first mobile device 100a can include sounding an audible alert, displaying a route map with the route location of the second mobile device 100b, displaying directions to the route location, displaying an estimated travel time to the route location, etc.

Other processes for locating users of mobile devices located in a proximity radius to a route can also be used.

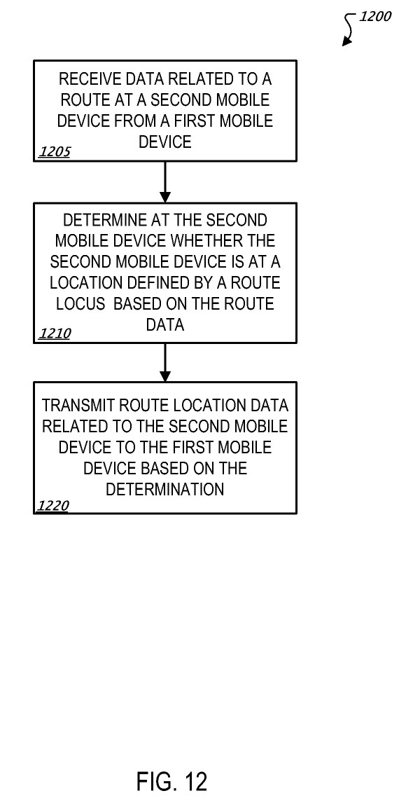

FIG. 12 is a flow diagram of another example process for transmitting a route between mobile devices and locating users of the mobile devices at a location defined by a route locus. The process 1200 can, for example, be implemented in the route engine 402 or the mobile device route engine 404.

Stage 1205 receives data related to a route at a second mobile device from a first mobile device. In one implementation, the route data received at the second mobile device 100b can include a route map that can be displayed on the second mobile device 100b. Other types of route data can also be received at the second mobile device 100b.

Stage 1210 determines at the second mobile device whether the second mobile device is at a location defined by a route locus based on the route data. In one implementation, determining whether the second mobile device 100b is at a location defined by a route locus can include comparing location data from a global positioning satellite receiver 316 in communication with the second mobile device 100b to the route data received from the first mobile device 100a.

In another implementation, the determination of whether the second mobile device 100b is at a location defined by a route locus can include a determination of whether the second mobile device 100b is located in a proximity radius to the route based on the route data. Determining whether the second mobile device is at a location defined by a route locus to the route can, for example, be determined by a route engine 402 or a mobile device route engine 404 located in the first mobile device 100a.

Stage 1215 transmits route location data related to the second mobile device to the first mobile device based on the determination that the second mobile device is at a location defined by a route locus. In another implementation, route location data related to the second mobile device 100b can be transmitted to the first mobile device 100a based on the determination that the second mobile device 100b is at a location defined by a route locus to the route.

In one implementation, transmitting route location data related to the second mobile device 100b to the first mobile device 100a can include transmitting a route map with the route location of the second mobile device 100b to the first mobile device 100a, transmitting directions to the route location, transmitting an estimated travel time to the route location, etc.

Other processes for transmitting a route between mobile devices and locating users of the mobile devices at a location defined by a route locus can also be used.

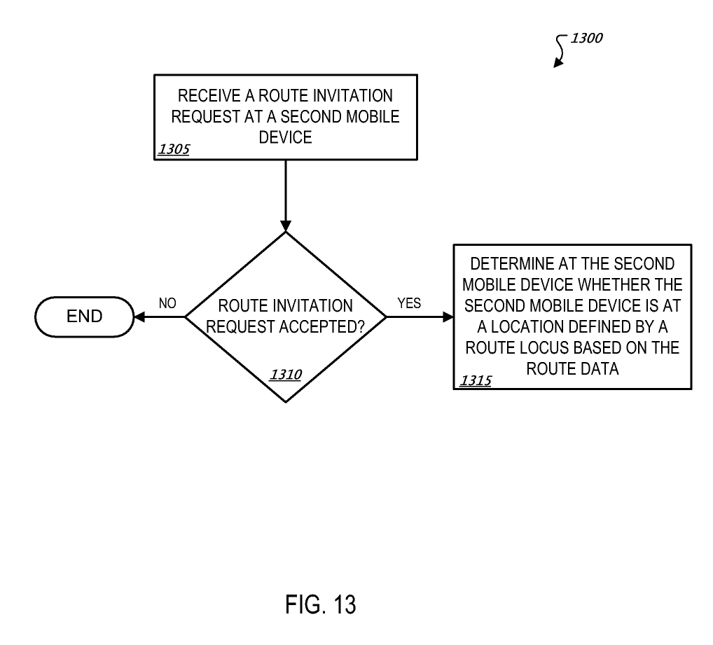

FIG. 13 is a flow diagram of an example process 1300 for receiving a route invitation request. The process 1300 can, for example, be implemented in the route engine 402 or the mobile device route engine 404.

Stage 1305 receives a route invitation request at a second mobile device. For example, the route invitation request can include a request from the first mobile device 100a requesting the second mobile device 100b to share location information with the first mobile device 100a when the mobile devices 100a and 100b are at a location defined by a route locus. In one implementation, the user of the second mobile device 100b can accept the route invitation request. In another implementation, the user of the second mobile device 100b can reject the route invitation request.

Stage 1310 determines whether the user of the second mobile device 100b accepts the route invitation request. In response to the user accepting the route invitation request, the example process 1300 can proceed to Stage 1315.

Stage 1315 determines at the second mobile device whether the second mobile device is at a location defined by a route locus based on the route data, in response to the second mobile device accepting the route invitation request. For example, in response to accepting the route invitation request, the user of the second mobile device 100b can approve the user of the first mobile device to view the location information of the second mobile device 100b when the mobile devices 100a and 100b are at a location defined by a route locus.

Other processes for receiving data related to a route at a second mobile device from a first mobile device can also be used.

The apparatus, methods, flow diagrams, and structure block diagrams described in this patent document can be implemented in computer processing systems including program code comprising program instructions that are executable by the computer processing system. Other implementations can also be used. Additionally, the flow diagrams and structure block diagrams described in this patent document, which describe particular methods and/or corresponding acts in support of steps and corresponding functions in support of disclosed structural means, can also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art can effect alterations, modifications and variations to the examples without departing from the scope of the invention.

What is claimed is:

1. A method, comprising:
transmitting data related to a route from a first mobile device to a second mobile device;
receiving at the first mobile device location data related to the second mobile device;
determining at the first mobile device whether the second mobile device is at a location defined by a route locus based on the location data; and
indicating at the first mobile device a route location of the second mobile device based on the determination.

2. The method of claim 1, wherein transmitting data related to the route from the first mobile device to the second mobile device further comprises:
presenting a route map to a multi-touch-sensitive display of the second mobile device.

3. The method of claim 1, wherein receiving at the first mobile device location data related to the second mobile device comprises:
receiving location data from a global positioning satellite receiver connected to the second mobile device.

4. The method of claim 1, wherein the route locus defines one or more locations coterminous with the route.

5. The method of claim 1, wherein the route locus defines one or more locations within a predefined proximity of the route.

6. The method of claim 5, wherein the predefined proximity of the route comprises:
a proximity radius.

7. The method of claim 1, wherein indicating at the first mobile device the route location of the second mobile device comprises:
sounding an audible alert at the first mobile device.

8. The method of claim 1, wherein indicating at the first mobile device the route location of the second mobile device comprises:
displaying a route map with the route location of the second mobile device on a multi-touch-sensitive display of the first mobile device.

9. The method of claim 1, wherein indicating at the first mobile device the route location of the second mobile device comprises:
displaying directions to the route location of the second mobile device on a multi-touch-sensitive display of the first mobile device.

10. The method of claim 1, wherein indicating at the first mobile device the route location of the second mobile device comprises:
displaying an estimated travel time to the route location of the second mobile device on a multi-touch-sensitive display of the first mobile device.

11. A method, comprising:
receiving data related to a route at a second mobile device from a first mobile device;
determining at the second mobile device whether the second mobile device is at a location defined by a route locus based on the route data; and
transmitting route location data related to the second mobile device to the first mobile device based on the determination.

12. The method of claim 11, wherein receiving data related to the route at the second mobile device from the first mobile device further comprises:
receiving a route map at the second mobile device.

13. The method of claim 11, wherein determining at the second mobile device whether the second mobile device is at a location defined by a route locus based on the route data comprises:
comparing location data from a global positioning satellite receiver connected to the second mobile device to the route data received from the first mobile device.

14. The method of claim 11, wherein the route locus defines one or more locations coterminous with the route.

15. The method of claim 11, wherein the route locus defines one or more locations within a predefined proximity of the route.

16. The method of claim 15, wherein the predefined proximity of the route comprises:
a proximity radius.

17. The method of claim 11, wherein transmitting route location data related to the second mobile device to the first mobile device based on the determination comprises:
transmitting a route map with the route location of the second mobile device to the first mobile device.

18. The method of claim 11, wherein transmitting route location data related to the second mobile device to the first mobile device based on the determination comprises:
transmitting directions to the route location of the second mobile device to the first mobile device.

19. The method of claim 11, wherein transmitting route location data related to the second mobile device to the first mobile device based on the determination comprises:
transmitting an estimated travel time to the route location of the second mobile device to a multi-touch-sensitive display of the first mobile device.

20. The method of claim 11, wherein receiving data related to the route at the second mobile device from the first mobile device comprises:
receiving a route invitation request at the second mobile device; and
in response to the second mobile device accepting the route invitation request, determining at the second mobile device whether the second mobile device is at a location defined by a route locus based on the route data.

21. A system, comprising:
a plurality of mobile devices configured to transmit and receive data related to a route; and
a route engine configured to:
determine whether a first mobile device of the plurality of mobile devices is at a location defined by a route locus based on route data transmitted from a second mobile device of the plurality of mobile devices and location data of the first mobile device; and
provide an indication at the second mobile device for a route location of the first mobile device based on the determination.

22. The system of claim 21, wherein the plurality of mobile devices comprise the route engine.

23. The system of claim 21, wherein the plurality of mobile devices comprise a global positioning satellite receiver.

24. The method of claim 21, wherein the route data transmitted from the second mobile device comprises:
a route map displayed on a multi-touch-sensitive display of the first mobile device.

25. The system of claim 21, wherein the indication is provided to a multi-touch-sensitive display of the second mobile device.

26. The system of claim 21, wherein the first mobile device and the second mobile device comprise an alarm device configured to provide an audible alert to the second mobile device in response to an indication provided by the route engine.

27. A system, comprising:
means for transmitting data related to a route from a first mobile device to a second mobile device;
means for receiving at the first mobile device location data related to the second mobile device;
means for determining at the first mobile device whether the second mobile device is at a location defined by a route locus based on the location data; and
means for indicating at the first mobile device a route location of the second mobile device based on the determination.

28. A computer program product, encoded on a computer readable medium, operable to cause data processing apparatus to perform operations comprising:
receiving data related to a route at a second mobile device from a first mobile device;
determining at the second mobile device whether the second mobile device is at a location defined by a route locus based on the route data; and
transmitting route location data related to the second mobile device to the first mobile device based on the determination.

29. A method, comprising:
receiving data related to a route from a first mobile device;
receiving location data from a second mobile device;
determining whether the second mobile device is at a location defined by a route locus based on the location data; and
providing to the first mobile device a route location of the second mobile device based on the determination.
